(19) United States
(12) Patent Application Publication
(10) Pub. No.: US 2003/0227390 A1
(43) Pub. Date: Dec. 11, 2003

(54) Low-battery-status informing device and method for portable electronic apparatus

(76) Inventors: Huang-Cheng Hung, Taoyuan (TW); Raymond Tsai, Taoyuan (TW); Nicholas Han, Taoyuan (TW); Tyrancy Wan, Taoyuan (TW); Eric Hsu, Taoyuan (TW); Jack Hsu, Taoyuan (TW)

Correspondence Address: MARTINE & PENILLA, LLP, 710 LAKEWAY DRIVE, SUITE 170, SUNNYVALE, CA, 94085, US

(21) Appl. No.: 10/165,564

(22) Filed: Jun. 7, 2002

(51) Int. Cl. G08B 21/00

(52) U.S. Cl. 340/636.1

(57) ABSTRACT

A low-battery-status informing device for portable electronic apparatus includes a power switch, a voltage level determination module and a status informing display. The power switch is provided for users to turn on the power of the portable electronic apparatus. The voltage level determination module compares the voltage level of the battery with a reference level and outputs a status determining signal. In response to the status determining signal, the status informing display outputs a status informing signal to users without waking up the portable electronic apparatus.

### BACKGROUND OF THE INVENTION

1. Field of the Invention

The present invention relates to a device of informing a low battery status and method thereof and, more particularly, to a device of informing a low battery status of portable electronic apparatus and method thereof.

2. Description of the Related Art

Along with the development of technology, various kinds of new portable electronic apparatus have been proposed to facilitate communications and data exchanges among users. The population of the users of portable electronic apparatus is growing rapidly. Since portable electronic apparatus requires batteries to maintain its normal operation, it is an important issue for portable electronic apparatus to monitor the voltage level of the battery, and to provide information about the battery status to users.

Referring to FIG. 1, in prior art, when the power of portable electronic apparatus is turned on (S10), the voltage level of its battery is compared with a minimum operation voltage (S11). When the voltage level of the battery is higher than the minimum operation voltage, the portable electronic apparatus is turned on for users to use (S12). An internal circuit of the portable electronic apparatus keeps monitoring the battery voltage status (S13). When the battery voltage is lower than a warning voltage (S14), the portable electronic apparatus displays a low-battery-status warning sign on its screen (S15). Also, the portable electronic apparatus is switched to a sleep mode through a software battery fault protection procedure (S16). During the sleep mode, the data stored in the device can be preserved. The device can be waked up, if its power is turned on, but will be switched automatically into the sleep mode again if the battery voltage level is still lower than the warning voltage.

If the battery voltage level is lower than the level of the minimum voltage when the power is turned on (S11), the internal circuit of the portable electronic apparatus performs a hardware battery fault protection procedure, which does not respond to the power-on action (S17). The hardware battery fault protection procedure keeps functioning until the battery voltage level is above the minimum operation voltage.

One disadvantage of the above-mentioned technique is that when the portable electronic apparatus is at the sleep mode, there may not be enough power to maintain a full operation of the portable electronic apparatus after the power is turned on. However, the power has to be turned on for users to know whether the device is under a low-battery-status condition. As a result, more battery power is consumed in order to wake up the portable electronic apparatus. Therefore, it is very inconvenient for users to check the battery status of the portable electronic apparatus.

Another disadvantage is that, during the hardware battery fault protection procedure, the portable electronic apparatus does not respond to the power-on action of users. Since there is no response to the power-on action of users from the portable electronic apparatus, the users cannot determine whether the portable electronic apparatus is in the hardware battery fault protection procedure or is going through a malfunction. Therefore, this conventional technique causes confusion and is also very inconvenient to use.

### SUMMARY OF THE INVENTION

In view of the above-mentioned disadvantages, an object of the present invention is to provide a device of informing a low battery status of portable electronic apparatus when the portable apparatus is at a sleep mode or is in a hardware battery fault protection procedure.

To achieve this object, the low-battery-status informing device for portable electronic apparatus according to the present invention includes a power switch, a voltage level determination module, and a status informing display. The power switch is for users to wake up the portable electronic apparatus. The voltage level determination module compares a voltage level of battery with a reference level and outputs a status determining signal based on the result of the comparison. The status informing display outputs a status informing signal to users in response to the status determining signal without waking up the portable electronic apparatus when the voltage level of the battery is below the reference level.

The present invention also provides a low-battery-status informing method for portable electronic apparatus, which includes a comparing step and a providing step. The comparing step compares a voltage level of the battery with a reference level when a user wants to wake up the portable electronic device. The providing step provides an informing signal to the user without waking up the portable electronic apparatus when the voltage level of the battery is below the reference level.

In an embodiment of the invention, multiple reference levels may be utilized. That is, the reference levels may include a first reference level of 3.7 V and a second reference level of 3.2 V. When the voltage level of the battery is below the first reference level and above the second reference level, a first status informing signal may be provided to the user. When the voltage level of the battery is below the second reference level, a second status informing signal may be provided to the user. The first status informing signal and the second status informing signal may be used to turn on light-emitting diodes of different colors.

The device of informing a low battery status and method thereof according to the present invention can provide the low battery status to users without turning on or waking up the portable electronic apparatus. As a result, the user can check the battery status of the portable electronic apparatus without consuming more battery power.

Moreover, the device and method according to the present invention may provide a low-battery-status signal to the user even when the portable electronic apparatus is in a hardware battery fault protection procedure. Therefore, the users will not feel confused whether the portable electronic apparatus is going through a malfunction or not.

### BRIEF DESCRIPTION OF THE DRAWINGS

FIG. 1 is a flowchart showing a conventional method of informing a low battery status of portable electronic apparatus.

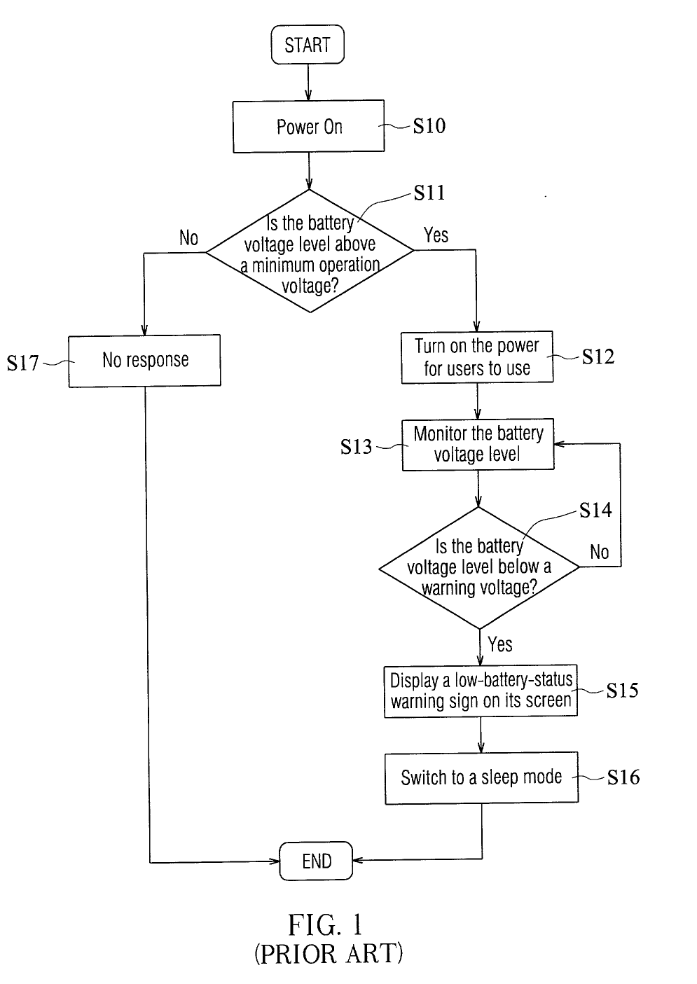

FIG. 2 is a circuit block diagram showing a device of informing a low battery status of portable electronic apparatus according to the present invention.

FIG. 3 is a flowchart showing a method of informing a low battery status of portable electronic apparatus according to the present invention.

FIG. 4 is a circuit diagram showing a detailed configuration of a device of informing a low battery status of portable electronic apparatus according to the present invention.

### DETAIL DESCRIPTION OF THE PREFERRED EMBODIMENT

The device and method of informing a low battery status of portable electronic apparatus according to an embodiment of the present invention will be described in detail with reference to the accompanying drawings, wherein the same reference numbers denote the same elements.

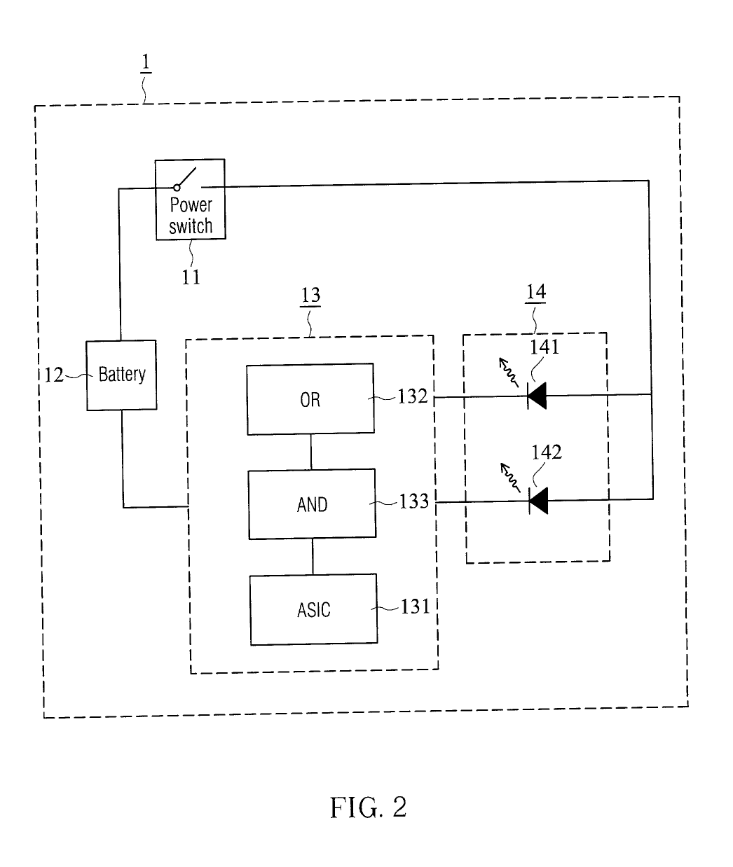

Referring to FIG. 2, portable electronic apparatus 1 according to the present invention includes a power switch 11, a battery 12, a voltage level determination module 13, and a status informing display 14. A device of informing a low battery status of the portable electronic apparatus 1 according to the present invention consists of the voltage level determination module 13 and a status informing display 14.

The power switch 11 is provided for users to turn on or wake up the power of the portable electronic apparatus 1. When the user switches the power switch 11, the voltage level determination module 13 compares the voltage level of the battery 12 with at least one reference level and outputs a status determining signal based on the result of the comparison. Subsequently, the status informing display 14 outputs a status informing signal in response to the status determining signal for users without waking up the portable electronic apparatus 1.

In the present embodiment, the voltage level determination module 13 includes an application-specific integrated circuit (ASIC) 131, a set of logical OR gates 132, and a set of logical AND gates 133. The ASIC 131 is built-in with a software battery fault protection program, which can determine the voltage level of the battery. The set of logical OR gates 132 and the set of logical AND gates 133 are connected to the ASIC 131 for outputting the status determining signal after logical operations.

The status informing display 14 may include a green light-emitting diode 141 and a red light-emitting diode 142 to clearly display the low battery status of the portable electronic apparatus 1.

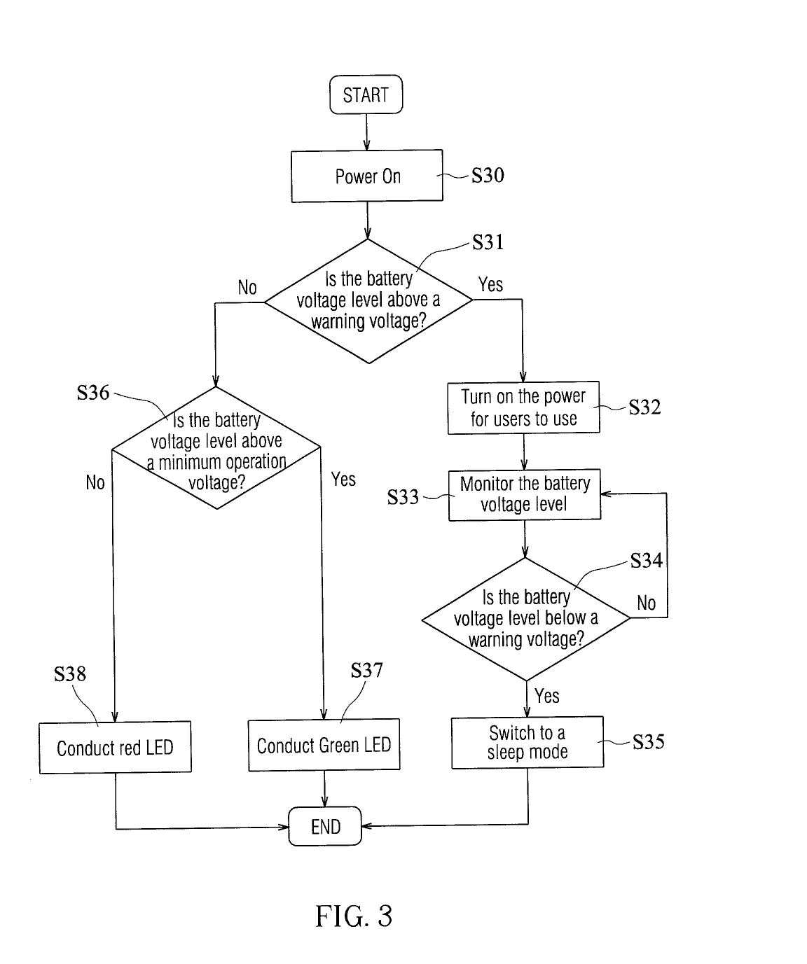

For the person skilled in the art to comprehend the present invention more easily, the method of informing a low battery status of portable electronic apparatus will be described in detail with reference to FIG. 3.

Referring to FIG. 3, according to the present invention, when a user switches the power switch 11 to turn on the power of portable electronic apparatus 1 (S30), the voltage level of the battery 12 is compared with a warning voltage level (S31). For example, in the present embodiment, the warning voltage level is 3.7 V. If the voltage level of the battery 12 is higher than the warning voltage, the power of the portable electronic apparatus 1 is then turned on (S32), and an internal circuit (not shown) of the portable electronic apparatus 1 keeps monitoring the battery voltage level (S33). When the battery voltage level is lower than the warning voltage (S34), the portable electronic apparatus displays a low-battery-status warning sign on its screen and switches to a sleep mode through a software battery fault protection procedure (S35).

If the voltage level of the battery 12 is lower than the warning voltage when a user tries to turn on the power of the portable electronic apparatus, the voltage level of the battery 12 is compared with a minimum operation voltage level (S36). For example, in the present embodiment, the minimum operation voltage level is 3.2 V. If the voltage level of the battery 12 is higher than the minimum operation voltage and lower than the warning voltage, the portable electronic apparatus 1 will not be turned on or waked up. In this condition, a first status informing signal is outputted to the user through the status informing display 14. For example, in the present embodiment, the first status informing signal is a green light signal emitted by a green light-emitting diode (LED) 141 (S37).

If the voltage level of the battery 12 is lower than the minimum operation voltage when a user tries to turn on the power of the portable electronic device, the portable electronic device performs a hardware battery fault protection procedure, which does not respond to the power-on action of the user. In this condition, a second status informing signal is outputted to the user through the status informing display 14. For example, in the present embodiment, the second status informing signal is a red light signal emitted by the red LED 142 (S38).

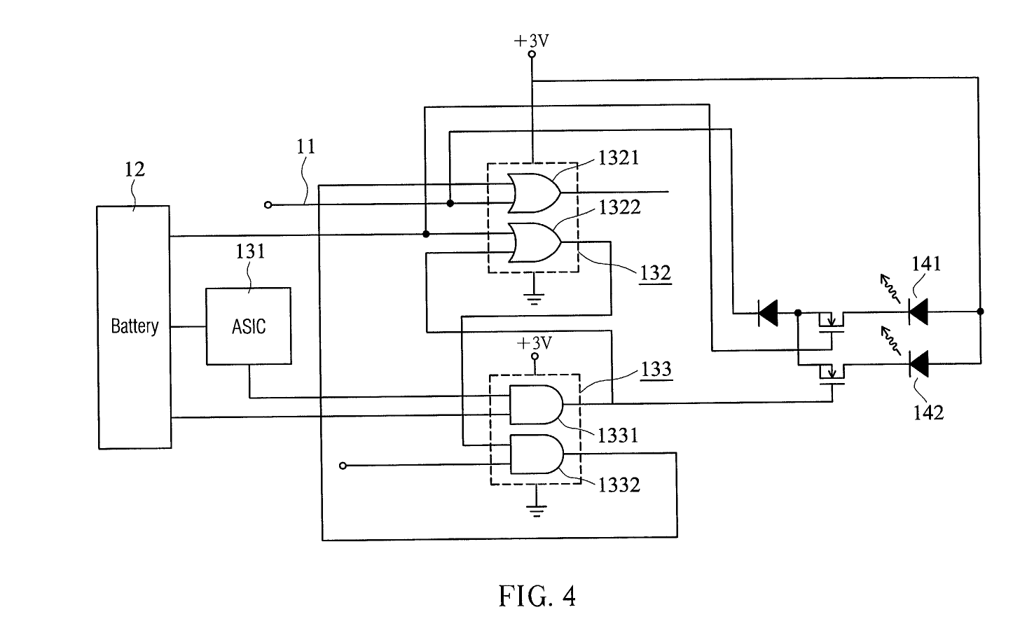

FIG. 4 is a circuit diagram showing a detailed configuration of a device of informing a low battery status of portable electronic apparatus according to the present invention. Referring to FIG. 4, the application-specific integrated circuit (ASIC) 131 has a function of memorizing the remaining volume of electric power of the battery 12 and is provided with a mechanism for determining the voltage level of the battery 12. The set of logical OR gates 132 consists of two OR gates 1321 and 1322 while the set of logical AND gates 133 consists of two AND gates 1331 and 1332. The output terminal of the OR gate 1322 is connected to one of the input terminals of the AND gate 1332 while the output terminal of the AND gate 1332 is connected to one of the input terminals of the OR gate 1321. If the voltage level of the battery 12 is lower than the warning voltage, the ASIC 131 outputs a logic “1” to one of input terminals of the AND gate 1331 while the battery 12 enables the software battery fault protection procedure to output a logic “1” to another of the input terminals of the AND gate 1331. As a result, the AND gate 1331 outputs a logic “1” to turn on the green LED 142.

When the voltage level of the battery 12 is lower than the minimum operation voltage, voltage detection IC (not shown) outputs a logic “1” by using the differential principle through the hardware battery fault protection procedure and turns on the red LED 141.

Since the device of informing a low battery status and method thereof according to the present invention can provide the low battery status for users without turning on or waking up the portable electronic apparatus, the users can check the battery status of the portable electronic apparatus without consuming more battery power. Furthermore, the device and method according to the present invention may provide a low-battery-status signal to the users even when the portable electronic apparatus is under a hardware battery fault protection procedure. Therefore, the users will not feel confused whether the portable electronic apparatus is having a malfunction or not.

While the invention has been described by way of examples and in terms of embodiments, it is to be understood that the invention is not limited to the disclosed embodiments. The scope of the appended claims should be accorded the broadest interpretation so as to encompass all equivalent modifications.

What is claimed is:

1. A low-battery-status informing device for portable electronic apparatus comprising:
a power switch for waking up the portable electronic apparatus by a user;
a voltage level determination module for comparing a voltage level of the battery of the portable electronic apparatus with a reference level and outputting a status determining signal; and
a status informing display for outputting a status informing signal in response to the status determining signal without waking up the portable electronic apparatus when the voltage level of the battery is determined below the reference level.

2. The low-battery-status informing device according to claim 1, wherein the voltage level determination module comprises:
an application-specific integrated circuit (ASIC) for determining the voltage level of the battery; and
a logical gate set connected with the ASIC for outputting the status determining signal after logical operations.

3. The low-battery-status informing device according to claim 2, wherein the logical gate set comprises at least one AND gate.

4. The low-battery-status informing device according to claim 2, wherein the logical gate set comprises at least one OR gate.

5. The low-battery-status informing device according to claim 1, wherein the status informing display comprises at least one light-emitting diode.

6. The low-battery-status informing device according to claim 1, wherein the status informing display comprises light-emitting diodes having different colors and each of the light-emitting diodes is conducted when the voltage level of the battery is below a corresponding reference level.

7. A low-battery-status informing method for portable electronic apparatus comprising the steps of:
comparing a voltage level of the battery with a first reference level when a user wants to wake up the portable electronic apparatus; and
providing a first status informing signal to the user without waking up the portable electronic apparatus when the voltage level of the battery is below the first reference level.

8. The low-battery-status informing method according to claim 7, wherein the step of providing the first status informing signal comprises turning on a first light-emitting diode.

9. The low-battery-status informing method according to claim 7, further comprising the steps of:
comparing the voltage level of the battery with a second reference level; and
providing a second status informing signal to the user when the voltage level of the battery is below the second reference level.

10. The low-battery-status informing method according to claim 9, wherein the step of providing the second status informing signal comprises turning on a second light-emitting diode.
